(19) United States
(12) Patent Application Publication
(10) Pub. No.: US 2003/0189732 A1
(43) Pub. Date: Oct. 9, 2003

(54) System and method for identifying prescriptions with captured images

(76) Inventors: Heather Noel Bean, Ft. Collins, CO (US); Mark Nelson Robins, Greeley, CO (US)

Correspondence Address: HEWLETT-PACKARD COMPANY, Intellectual Property Administration, P.O. Box 272400, Fort Collins, CO, 80527-2400, US

(21) Appl. No.: 10/118,777

(22) Filed: Apr. 8, 2002

(51) Int. Cl. G06F 15/00; H04N 1/23; B41B 1/00

(52) U.S. Cl. 358/302; 358/1.18

(57) ABSTRACT

One embodiment of the present invention provides a prescription label having at least an image of a client who is intended to consume a prescribed drug and a prescription information region identifying at least the prescribed drug.

### TECHNICAL FIELD

The present invention is generally related to capturing images using an image capture device. More particularly, the present invention is directed to identifying prescriptions with captured images.

### BACKGROUND OF THE INVENTION

It is desirable to identify with a high degree of reliability and accuracy prescription drug containers. Failure to reliably and accurately provide identification of a drug container may result in the person taking the drug to experience health problems.

For example, the person taking the drug may become sick from a drug that is consumed in error. Or, the person may not receive the intended benefits of the prescription drug because the person consumed the wrong drug or an incorrect dose of the intended drug. Sometimes, in extreme instances, taking an incorrect drug or failure to take a prescribed drug of the proper dosage may result in a person's death or severe disability.

Issuance of prescription drugs is regulated by United States Food and Drug Administration (FDA). Rules and procedures control the process whereby a person obtains prescription drugs. For example, a person first gets a prescription for a drug after visiting a doctor. The prescription drug is prescribed based upon the doctor's analysis of the person's medical condition. The person presents the prescription to the pharmacist at a pharmacy. After verification, the pharmacist fill the prescription by selling the person the prescribed drug. Typically, the drug is provided in a container, such as a pill bottle or the like. The pharmacist has carefully provided the correct amount of the prescribed drug, such as a number of pills or a measured amount of liquid. A label is affixed to the container indicating the name of the person that the drug was prescribed for, and other information of interest, such as expiration dates for the drug, dosage instructions, contra-indications and possible adverse reactions. Accordingly, the present system provides a relatively safe process whereby a person obtains prescription drugs. This process is hereinafter referred to as filling a prescription.

However, once the person has left the pharmacy with a filled prescription, several problems may occur. On occasion, the person taking the drug may mistakenly open a similarly looking container and consume the wrong drug. This problem becomes very real when the person's health is not good, when the person has been subscribed a plurality of drugs which may be provided in similar containers, when the person's eye sight or mental capacity is impaired, and/or during emergency situations where the person must quickly consume the prescribed drug.

Furthermore, some families have large numbers of children and/or elderly relatives living within the same household. Such family members, in addition to having the same surname, may have similar given names (e.g.: Robert Smith Sr., Robert Smith Jr., Robert Smith III, etc.). Accordingly, individuals may by accident consume prescription drugs prescribed to another family member, particularly in an emergency situation where a prescribed drug must be quickly consumed. The probability is further increased when the label on the prescription drug container is printed using a very small character font.

Also, prescription pills may become misplaced in a wrong pill container. For example, a person taking multiple prescribed pills at the same time may, when taking out a pills from a first pill bottle, remove too many pills. The extra pills, intended to be returned into the first pill bottle, may inadvertently be returned to another pill bottle. Or, for convenience, the person may place several different types of pills into the same container to facilitate transport of the pills. Or, different types of pills may be placed in a generic container, such as a container configured to provide daily doses of pills during the week. Although the person mixing the pills into one container may know what the pills are, others will not know. Thus, a pill bottle may contain multiple types of pills or may contain the wrong pill type.

Some prescription drugs, such as narcotics, are very desirable in the illegal, underground marketplace. Accordingly, unscrupulous individuals will try to get a pharmacist to fill a forged prescription. Such attempts may be successful if the pharmacist is not able to verify that the person attempting to fill the prescription and the person named in the prescription are the same.

Prescriptions are filled by the pharmacist. Pharmacists are people, and people occasionally make mistakes. Thus, a pharmacist may incorrectly fill a prescription by filling the drug container with the wrong drug. For example, the pharmacist may simply grab the wrong bulk pill container from the supply shelf and use the pills from the wrong bulk bottle to fill the prescription. Such an inadvertent, innocent mistake by the pharmacist may have extremely undesirable consequences to the person taking the wrong drug.

Furthermore, to verify that the pharmacist has properly filled a prescription with the correct drugs and/or dosage, a person receiving a prescription must look to a reference source, such as the Physician's Desk Reference (PDR) or similar book, or on the Internet. Such reference sources are not available to all individuals. Furthermore, some generic drugs that replace name-brand drugs may not be described and/or pictured in the available reference sources.

Hospitals provide medication to large numbers of patients on a nearly constant basis. Such prescription drugs are typically provided by doctors, nurses or other individuals authorized to dispense prescribed drugs. However, with large numbers of patients, it is possible that drug containers may be mixed up such that the wrong prescribed drugs are consumed by some patients. For example, an unconscious patient or an otherwise incapacitated patient may be incorrectly identified. Such a person would likely receive prescription drugs based upon the incorrect identification. Thus, if Bob Smith is incorrectly identified as Robert Smith while in the hospital, Bob may receive Robert's prescription drugs in error.

Often emergency medical technicians (EMTs), such as firemen, ambulance personnel, police officers, render emergency aid to individuals. The EMT rendering aid to an unconscious person or an otherwise incapacitated person may need to know what prescription drugs the person may be currently taking. Thus, the EMT must carefully scrutinize any prescription drug containers to determine if the person receiving emergency aid is the individual named on the label of the prescription drug container. Furthermore, the process of determining which drugs that the person receiving aid may have taken may be complicated if there are multiple prescriptions to be evaluated, and/or if there are multiple prescriptions filled to multiple persons (and the name of the person receiving aid can not be determined by the EMT). Such a process is time consuming and subject to error.

### SUMMARY OF THE INVENTION

An embodiment of the present invention provides a prescription label having at least an image of a client who is intended to consume a prescribed drug and a prescription information region identifying at least the prescribed drug. Another embodiment of the present invention may be summarized broadly as a method for preparing prescription labels comprising the steps of capturing an image of a client who is intended to consume a prescribed drug and printing a prescription label having at least the image of the client.

### BRIEF DESCRIPTION OF THE DRAWINGS

The components in the drawings are not necessarily to scale relative to each other. Like reference numerals designate corresponding parts throughout the several views.

FIG. 1 is a block diagram of one embodiment of a prescription label prepared according to the present invention.

FIG. 2 is a block diagram illustrating one embodiment of a system in accordance with the present invention having at least a digital camera, a personal computer, a display and a printing device.

FIG. 3 is a block diagram of selected components of a digital camera according to the present invention.

FIG. 4 is a flowchart of a process describing one embodiment of the present invention.

FIG. 5 is a block diagram illustrating an alternative embodiment of a prescription label unit.

FIG. 6 is a block diagram illustrating an alternative embodiment of a prescription label unit.

FIG. 7 is a flowchart of a process describing an alternative embodiment of the present invention.

### DETAILED DESCRIPTION OF THE PREFERRED EMBODIMENT

The present invention provides a system and method for identifying prescription with at least one captured image incorporated into a prescription label applied to a prescription drug container. Preferably, the captured image is of the person who is intended to be the consumer of the prescribed drug. The person who is intended to be the consumer of the prescribed drug is hereinafter referred to as the client.

Another embodiment further includes an image of the prescribed drug. Accordingly, the pharmacist filling the prescription can verify that the correct drug has been provided by comparing the image of the prescribed drug with the actual drug used to fill the prescription. Similarly, the client consuming or administering the prescribed drug can verify that the correct drug has been filled and/or is being consumed. Furthermore, the captured image of the client provides verification that the correct person is consuming the prescribed drug.

Yet another embodiment includes personal information associated with the client, such as, but not limited to, known allergies and/or adverse reactions, on the prescription label. Furthermore, contra-indications associated with the prescribed drug can be indicated on the prescription label. For example, a contra-indication may specify that client should not consume other types of drugs when the prescribed drug is consumed. Thus, in a situation where an emergency medical technician (EMT) is administering aid to a client having a prescription label in accordance with the present invention, the EMT can quickly and reliably determine what prescription drugs the client may be consuming. Furthermore, contra-indication information on a prescription label prepared in accordance with the present invention may assist the EMT in avoiding the administering of drugs that could present a health risk to the client.

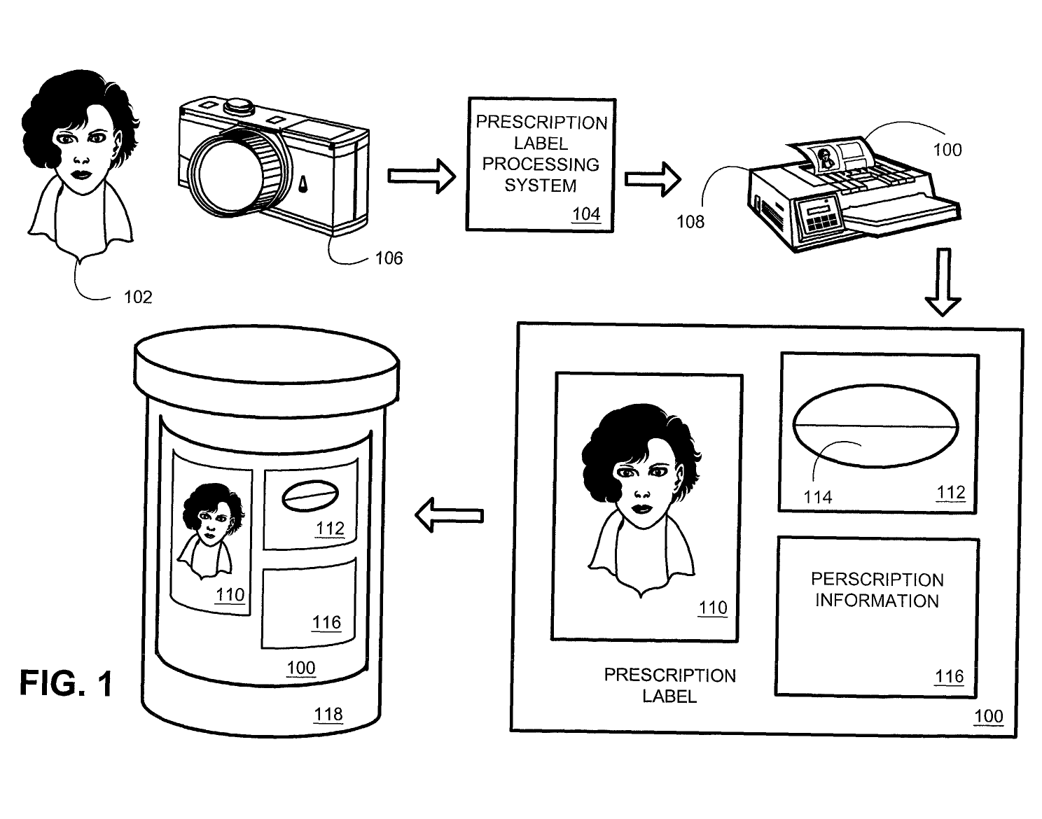

FIG. 1 is a block diagram of one embodiment of a prescription label 100 prepared according to the present invention. Once a client 102 and the prescribed drug have been identified, a prescription label processing system 104, described in greater detail below, prepares prescription label 100 in accordance with the present invention. An image of the client 102 is captured with an image capture device, such as digital camera 106. The captured client image is then transferred to the prescription label processing system 104 such that the prescription label 100 is prepared. Once prepared, prescription label 100 is printed using a suitable printing device 108.

For convenience, one embodiment of the present invention is described as being implemented in, or being a part of, a digital camera 106. The present invention is equally applicable to any electronic device configured to capture images of the client and configured to prepare prescription labels in accordance with the present invention. For example, but not limited to, an alternative embodiment retrieves previously captured client images from a memory to prepare prescription labels in accordance with the present invention. Another exemplary embodiment incorporates an image capture device as a component of a label processing system. Yet another exemplary embodiment employs an image capture device configured to print an image of the client on a small label that is affixed to a prescription container.

The embodiment of the prescription label 100 illustrated in FIG. 1 includes at least a client image 110 of the client 102, an image of the prescribed drug 112, such as, but not limited to, pill 114, and prescription information 116. For convenience, a pill 114 is illustrated on the captured image of the prescribed drug 112. Alternatively, the prescribed drug could be a tablet, a capsule, a liquid or any other suitable medium in which the prescribed drug is delivered to and/or consumed by the client. Furthermore, if the prescription drug is in a medium that is provided in a specialized container, such as, but not limited to, an inhaler, an image of the specialized container could be substituted for an image of the prescription drug itself and printed on the prescription label 100.

The prescription label 100 is printed on a suitable material such that the prescription label 100 is affixed to the prescription container 118. For convenience, the prescription container 118 is illustrated as a pill bottle. Alternatively, prescription label 100 can be affixed to any suitable container that is given to client 102 when the client's prescription is filled.

Any suitable means for affixing the prescription label 100 to prescription container 118 may be employed. For example, but not limited to, prescription label 100 can employ a peel-away sticker having a self-adhesive material applied to the back-side of prescription label 100, can employ an adhesive compound that becomes adhesive when a liquid or moisture is applied, or may employ a clear tape applied over the surface of prescription label 100 such that prescription label 100 is affixed (taped) to prescription container 118. Prescription label 100 may even be printed directly onto a prescription container that is configured to have printing directly applied to the prescription container by a suitable printing device 108.

As illustrated in FIG. 1, prescription container 118 having a prescription label 100 prepared according to the present invention readily identifies client 102 with client image 110. Thus, any person viewing prescription label 100 can ascertain the identity of client 102.

In an embodiment employing an image of the prescribed drug 112, any person viewing prescription label 100 can ascertain the identity of the prescription drug that should be contained within prescription container 118. Furthermore, in an embodiment that receives information identifying the intended drug to be prescribed, either from the scanning of the prescription drug bulk container or from information provided by the pharmacist, as described in greater detail below, an image of the prescribed drug 112 can be retrieved from a pharmaceutical database. Accordingly, any person viewing prescription label 100 can ascertain that the prescription drug contained in prescription container 118 matches with the intended prescription drug.

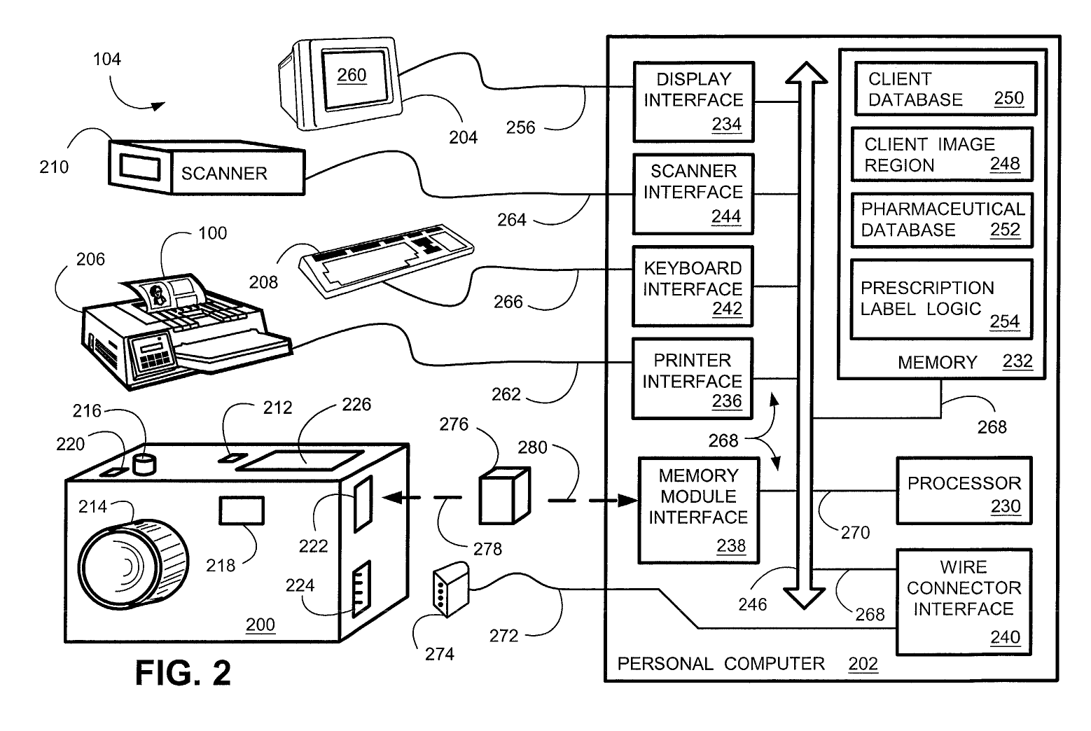

FIG. 2 is a block diagram illustrating one embodiment of a prescription label processing system 104 in accordance with the present invention having at least a digital camera 200, a personal computer 202, a display 204, a printing device 206, a user interface device 208 (keyboard) and a scanner 210.

Digital camera 200 includes at least a control button 212, a lens unit 214, an image capture actuation button 216, a viewing lens 218, a power switch 220, memory unit interface 222, a plug-in interface 224 and display 226. Display 226 is used for previewing images prior to capturing or for viewing captured images of the client and/or the prescription drug. For convenience of illustration, display 226 is illustrated on the top of digital camera 200.

FIG. 2 further illustrates a personal computer 202 that is employed with digital camera 200 such that digital images captured by the digital camera 200 may be retrieved, processed and/or printed in accordance with the present invention. Personal computer 202 includes at least a processor 230, a memory 232, a display interface 234, a printer interface 236, a memory module interface 238, a wire connector interface 240, a keyboard interface 242, a scanner interface 244 and a communication bus 246. Memory 232 further includes a client image region 248 where at least one image of a client resides, a client data base 250 where information corresponding to the client resides, a pharmaceutical database 252 where information corresponding to prescription drugs reside, and prescription label logic 254. The client image region 248, client data base 250, pharmaceutical database 252 and prescription label logic 254 are described in greater detail below. Memory 232 may also contain other data, logic and/or information used in the operation of personal computer 202, however such data, logic and/or information are described herein only to the extent necessary to describe the present invention.

Personal computer 202 is illustrated as being coupled to display 204, via connection 256, so that captured images of the client, images of the prescription drug, prescription information, and/or the prescription label 100 prepared in accordance with the present invention can be viewed on display 260. Personal computer 202 is further illustrated as being coupled to printer 206, via connection 262, so that prescription label 100 may be printed. Personal computer 202 is illustrated as being coupled to scanner 210, via connection 264, so that bar code information residing on a bulk container of prescription drugs can be scanned. Also, personal computer 202 is illustrated as being coupled to keyboard 208, via connection 266, so that the pharmacist can input relevant information regarding the client and the prescribed drug such that selected information can be incorporated into prescription label 100 in accordance with the present invention.

Memory 232, display interface 234, printer interface 236, memory module interface 238, wire connector interface 240, keyboard interface 242 and scanner interface 244 are coupled to communication bus 246 via connections 268. Communication bus 246 is coupled to processor 230 via connection 270, thereby providing connectivity to the above-described components. In alternative embodiments of personal computer 220, the above-described components are connectivley coupled to processor 230 in a different manner than illustrated in FIG. 2. For example, one or more of the above-described components may be directly coupled to processor 230 or may be coupled to processor 230 via intermediary components (not shown).

For convenience, user interface device 208 is illustrated as and is hereinafter referred to as keyboard 208. Other suitable user interfaces are employed in alternative embodiments such that a pharmacist filling a prescription in accordance with the present invention is able to input textual information that is printed on the prescription information 116 portion of prescription label 100 (FIG. 1).

In one embodiment of digital camera 200, digital camera 200 transfers captured client images to personal computer 202 via a hard wire connection 272. Connection 272 is coupled to plug-in attachment 274. Plug-in attachment 274 is configured to connect to plug-in interface 224. The pharmacist or other individual preparing prescription label 100 simply connects plug-in attachment 274 to plug-in interface 224 thereby establishing connectivity between digital camera 200 and personal computer 202. The pharmacist or other individual preparing prescription label 100 then instructs personal computer 202 and/or digital camera 200 to transfer digital captured client images from digital camera 200 into the client image region 248. An alternative embodiment configured to capture images of the prescribed drug communicates captured images of the prescribed drug to a suitable location in memory 232 in a similar manner.

In another embodiment, captured client images are stored in memory module unit 276. When capturing images with digital camera 200, memory module unit 276 is coupled to digital camera 200 through memory unit interface 222, as illustrated by dashed line path 278. Captured client images are transferred to personal computer 202 by removing memory module unit 276 from digital camera 200 and coupling memory module unit 276 to memory module interface 238. Typically, a convenient coupling port or interface (not shown) is provided on the surface of personal computer 202 such that memory module unit 276 is directly coupled to personal computer 202, as illustrated by dashed line path 280. Once memory module unit 276 is coupled to memory module interface 238, captured client images are transferred into the client image region 248. An alternative embodiment configured to capture images of the prescribed drug, communicates captured images of the prescribed drug to a suitable location in memory 232 in a similar manner.

For convenience, personal computer 202 is illustrated as having only selected components of interest. However, personal computer 202 may include additional internal components that are not illustrated in FIG. 2. These additional components are not shown and are not described in detail herein other than to the extent necessary to understand the functionality and operation of the present invention.

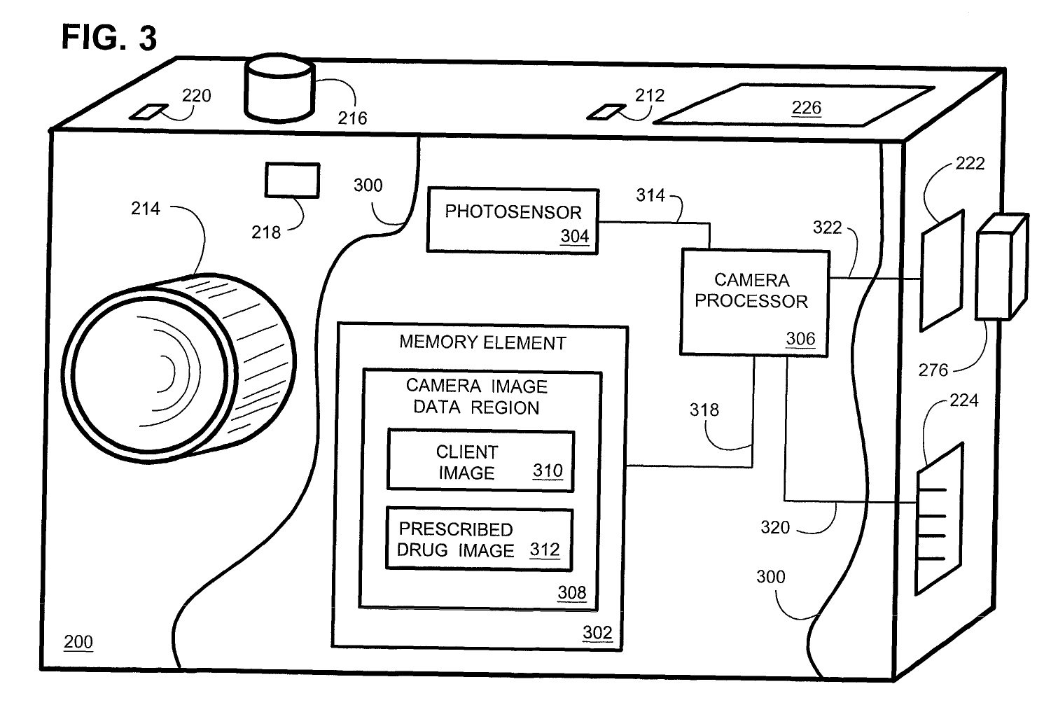

FIG. 3 is a block diagram of selected components of a digital camera 200 according to the present invention. FIG. 2 includes selected external and internal components of digital camera 200, demarked by cut-away lines 300. The internal components include at least memory element 302, photosensor 304 and camera processor 306. In one embodiment, memory element 302 further includes a camera image data region 308 configured to store at least client image 310. Another embodiment is further configured to store at least prescribed drug image 312.

Operation of digital camera 200 is initiated by actuation of the power switch 220 or an equivalent device having the same functionality. Display 226 may display a view of an image currently visible through the lens unit 214 and detected by photosensor 304, referred to herein as a preview image. When digital camera 200 is displaying a preview image, digital camera 200 is referred to herein as operating in a preview mode.

Alternatively, an image of a previously captured image may be viewed on display 226. When digital camera 200 is displaying a previously captured image, digital camera 200 is referred to herein as operating in a review mode. Furthermore, a menu screen may be displayed on display 226. In one embodiment, other buttons, switches or control interface devices (not shown) are additionally configured to operate display 226 such that menu items may be selected.

Prior to capturing an image of the client, the operator of the digital camera 200 may visually preview the image of the client and/or the image of the prescribed drug on display 226. Or, the image of the client and/or the image of the prescribed drug may be viewed directly through the viewing lens 218. Photosensor 304 is disposed in a suitable location behind lens unit 214 such that an image of the client and/or the image of the prescribed drug may be focused onto photosensor 304 for capturing. When the operator has focused the image of the client and/or the image of the prescribed drug and is satisfied with the focused image, the operator actuates the image capture actuation button 216 (also referred to as a shutter button or a shutter release button) to cause digital camera 200 to capture the image of the client and/or the image of the prescribed drug, thus “photographing” the client and/or the prescribed drug. Photosensor 304 detects the image of the client and/or the image of the prescribed drug through lens unit 214 and communicates digital image data corresponding to the detected image to the camera processor 306, via connection 314.

In one embodiment, the digital image data corresponding to the captured image is communicated to the memory element 302, via connection 316. In accordance with the present invention, when an image of the client is captured, the digital image data corresponding to the image of the client is stored in the camera image data region 308 as the client image 310.

Similarly, in another embodiment, when an image of the prescribed drug is captured, digital image data corresponding to the image of the prescribed drug is stored in the camera image data region 308 as a prescribed drug image 312. Control button 212, in one embodiment, is used to indicate whether the captured image corresponds to the client or corresponds to the prescribed drug. Alternative embodiments employ other suitable devices or a menu to specify that the captured image corresponds to the client or the prescribed drug.

Designating a captured image as a client image or a prescribed drug image defines the location of the captured image and/or the size of the captured image on prescription label 100. One embodiment of the present invention employs a prescription label template having predefined regions for client images, and/or prescribed drug images, and/or other information.

Accordingly, the camera image data region 308 is configured to store many client images 310 and/or prescribed drug images 312. In an embodiment employing hard wire connection 272 to communicate captured images to personal computer 202, the client image 310 and/or the prescribed drug image 312 is communicated from the digital camera to the hard wire connection 272 over connection 318, connection 320 and plug-in interface 224.

In another embodiment, digital image data is transferred to the memory module unit 276. When capturing images with digital camera 200, memory module unit 276 is coupled to digital camera 200 through the memory unit interface 222. As the user of digital camera 200 actuates the image capture actuation button 216 to cause the camera processor 306 to capture the current image detected by photosensor 304, camera processor 306 communicates the digital image data to the memory module unit 276, via connection 322 and the memory unit interface 222. Accordingly, memory module unit 276 is configured to store many client images and/or prescribed drug images.

For convenience, digital camera 200 is described above as employing both a memory element 308 and a memory module unit 218 to store captured images. Preferably, digital camera 200 would, in practice, employ either memory element 308 or memory module unit 218 to store captured images because employing two different and separate memory systems would be inefficient and costly. (However, it is possible some embodiments of digital camera 200 could employ both memory element 308 and memory module unit 218.)

In accordance with the embodiment of the prescription label system 104 illustrated in FIG. 2, the pharmacist captures an image of the client 102 when the client presents a prescription for filling. The client image 110 is communicated from the digital camera 200 to the personal computer 202, and is stored in the client image region 248 of memory 232 using any of the above-described processes.

As part of the process of filling the prescription, the pharmacist retrieves a bulk container having a quantity of the prescribed drug. The pharmacist then transfers an amount of the prescribed drug (a volume if the prescribed drug is in liquid form, or a number of units if the prescribed drug in pill, tablet or capsule form) into a container suitable for giving to the client 102. Such bulk containers typically employ bar codes identifying at least the type of drug residing in the bulk container.

Information for a plurality of drugs dispensed by the pharmacist is stored in pharmaceutical data base 252. In one embodiment, an image of each prescription drug, or selected prescription drugs, is included in pharmaceutical data base 252. Other information, such as contra-indications, may be included in pharmaceutical data base 252.

The pharmacist, in one embodiment, scans the bar code on the bulk container with scanner 210. The drug type information (and other information of interest encoded in the bard code) is communicated to personal computer 202. Processor 230 causes execution of the prescription label logic 254 such that the drug type information from the scanner is correlated with information residing in pharmaceutical data base 252 for the prescribed drug. Other information of interest encoded in the bard code may include, but is not limited to, batch number, drug expiration date and/or dosage information.

The pharmacist inputs information regarding client 102, using keyboard 208 or another suitable interface device. As the processor 230 executes prescription label logic 254, this input client information is stored into client database 250. Client information may include, but is not limited to, address, sex, age, medical history, allergies and/or other health conditions.

In an embodiment where an image of the prescribed drug is captured, the prescribed drug image 312 is communicated from the digital camera 200 to the personal computer 202, and is stored in a suitable location in memory 232, such as in pharmaceutical database 252 or client database 250.

Once a client 102 and the prescribed drug have been identified, prescription label logic 254, described in greater detail below, is executed such that prescription label 100 is prepared by retrieving an image of the client from client database 250, by retrieving an image of the prescribed drug from pharmaceutical database 252, and from selected information of interest. The above-described images and selected information is formatted by prescription label logic 254 into a prescription label 100. Information corresponding to prescription label 100 is communicated to display 204 for review and verification by the pharmacist filling the prescription. If changes are required, the pharmacist specifies such changes, via keyboard 208 or another suitable interface device, such that prescription label logic 254 reformats prescription label 100. When prescription label 100 is verified and acceptable, the information corresponding to prescription label 100 is communicated to printer 206.

Once information corresponding to prescription label 100 is received by printer 206, prescription label 100 is printed by printer 206. Printer 206 is configured to appropriately format and print the prescription label 100 on a suitable blank label (not shown). The blank label can be any suitable label material, described above, that can be affixed to prescription container 118. For example, but not limited to, blank labels may already be precut for easy access by the pharmacist. In another embodiment, a plurality of blank labels may be provided on a roll or a sheet such that the pharmacist need only peel-away a self-adhesive label, or detach the prescription label 100 from the roll or sheet. Furthermore, such a sheet or roll of blank labels may be pre-printed to have a plurality of regions defined by lines and/or borders that identify the regions on prescription label 100 where the above-described images and information is to be printed. Yet another embodiment may print prescription label 100 directly onto a suitable prescription container.

The above-described embodiment prepares prescription label 100 with prescription information 116. Prescription information 116 may include, but is not limited to, the client's name, identification of the prescribed drug, dosage amounts, times that the client 102 should consume the prescribed drug, expiration date of the prescribed drug, contra-indications and possible adverse reactions. Furthermore, prescription information 116 may include other information of interest, such as, but not limited to, information identifying the pharmacy, information identifying the pharmacist filling the prescription, date that the prescription was filled, the prescribing doctor, emergency contact information, medical and/or legal warnings, or the like.

In one embodiment, previously captured images of client 102 are used to prepare a prescription label 100 in accordance with the present invention. Thus, an image of a client 102 need only be captured one time and stored in the client image region 248. Such an embodiment allows a prescription to be presented over the phone or other suitable media for later pick-up by the client or an authorized third party.

When personal computer 202 is in operation, processor 230 is configured to communicate data to and from memory 232, to retrieve and execute the prescription label logic 254, and to generally control operations of personal computer 202. When prescription label logic 254 is implemented in software, it should be noted that prescription label logic 254 can be stored on any computer readable medium for use by or in connection with any computer related system or method. Likewise, captured client images 310, images of prescription drugs, and/or other information of interest regarding the client and/or prescription drugs, can also be stored on any suitable computer readable medium. In the context of this document, a computer readable medium is an electronic, magnetic, optical, or other physical device or means that can contain or store a computer program for use by or in connection with a computer related system or method. Memory 232 can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can store, communicate, propagate, or transport the program for use by or in connection with the instruction execution system, apparatus, or device. The computer readable medium can be, for example but not limited to, an electronic, magnetic, optical, electromagnetic, infrared, or semiconductor system, apparatus, device, or propagation medium. More specific examples (a nonexhaustive list) of the computer-readable medium would include the following: an electrical connection (electronic) having one or more wires, a portable computer diskette (magnetic, compact flash card, secure digital, or the like), a random access memory (RAM) (electronic), a read-only memory (ROM) (electronic), an erasable programmable read-only memory (EPROM, EEPROM, or Flash memory) (electronic), an optical fiber (optical), and a portable compact disc read-only memory (CDROM) (optical).

In an alternative embodiment, where prescription label logic 254 is implemented as firmware, as hardware or a combination of firmware and hardware, prescription label logic 254 can be implemented with any or a combination of the following known technologies: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

For convenience of illustration in FIG. 2, client image region 248, client database 250, pharmaceutical database 252 and prescription label logic 254 are shown residing in memory 232. Client image region 248, client database 250, pharmaceutical database 252 and/or prescription label logic 254 may reside in alternative convenient location outside of the memory 232, as components of other systems, or as stand alone dedicated memory element without adversely affecting the operation and functionality of the prescription label processing system 104. For example, but not limited to, the pharmaceutical database 252 may reside on a compact disk (CD) or other suitable portable memory medium that is coupled to personal computer 202. In another embodiment, pharmaceutical database 252 resides in a remote memory such that the personal computer accesses the remote memory on an as-needed basis, such as through the Internet, a wireless system, telephone system or the like.

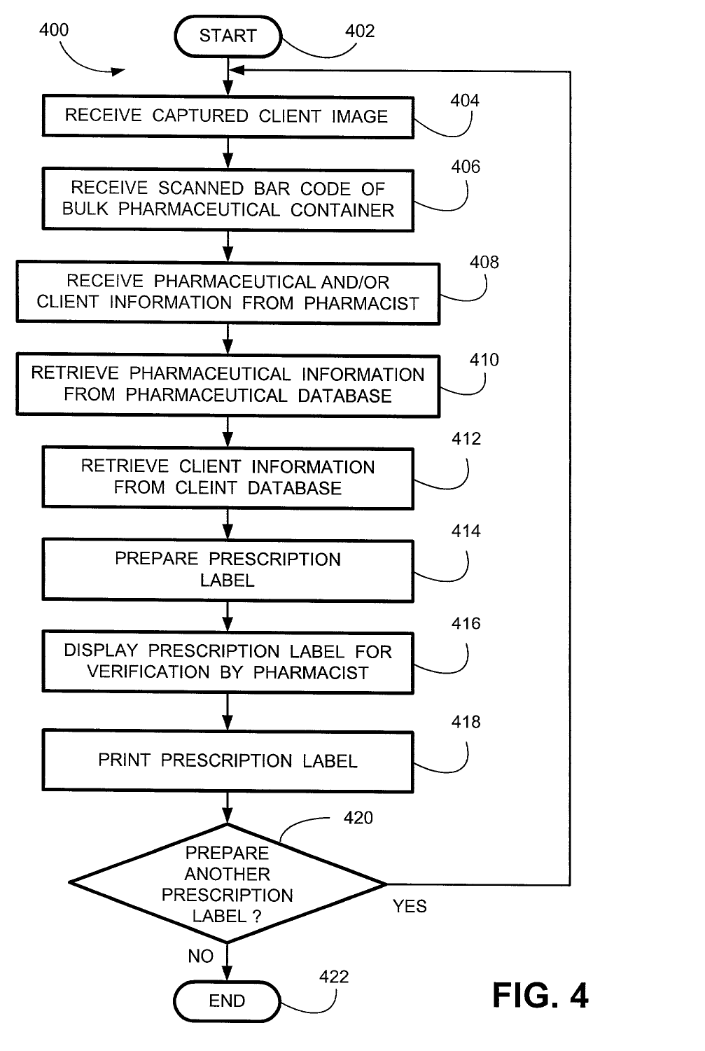

FIG. 4 is a flowchart 400 of a process describing one embodiment of the present invention. Flowchart 400 shows the architecture, functionality, and operation of one implementation of a system for preparing prescription labels 100 in accordance with the present invention. In this regard, each block represents a module, segment, or portion of code, which comprises one or more executable instructions for implementing the specified logical function(s). It should also be noted that in some alternative implementations, the functions noted in the blocks may occur out of the order noted in FIG. 4. For example, two blocks shown in succession in FIG. 4 may in fact be executed substantially concurrently or the blocks may sometimes be executed in the reverse order, depending upon the functionality involved, as will be further clarified hereinbelow.

The process of preparing prescription label 100 using an embodiment of the prescription label processing system 104 starts at block 402. At block 404, a client image 110 that has been previously captured by an image capture device, such as, but not limited to, digital camera 200, is received. Alternatively, a client image 110 may be received from the client image region 248.

At block 406, a scanned bar code from the bulk pharmaceutical container is received. As described above, the prescribed drug is typically dispensed from a bulk pharmaceutical container having bar codes. The pharmacist filling the prescription would scan the bar code with scanner 210.

At block 408, pharmaceutical information provided by the pharmacist is received. As described above, the pharmacist may enter the client's name and/or other information of interest using keyboard 208 or another suitable interface device.

At block 410, pharmaceutical information is retrieved from the pharmaceutical database 252. At block 412, client information is retrieved from the client database 250. At block 414, the received client image, client information, prescription drug information and other information of interest is used to prepare a prescription label 100. At step 416, an image of the prepared prescription label 100 is displayed on display 204 so that prescription label 100 can be verified by the pharmacist. At block 418 prescription label 100 is printed.

At block 420, a decision is made to prepare another prescription label 100. If another prescription label 100 is to be prepared (the YES condition), the process returns to block 404. If no other prescription labels 100 are to be prepared (the NO condition), the process proceeds to block 422 and ends.

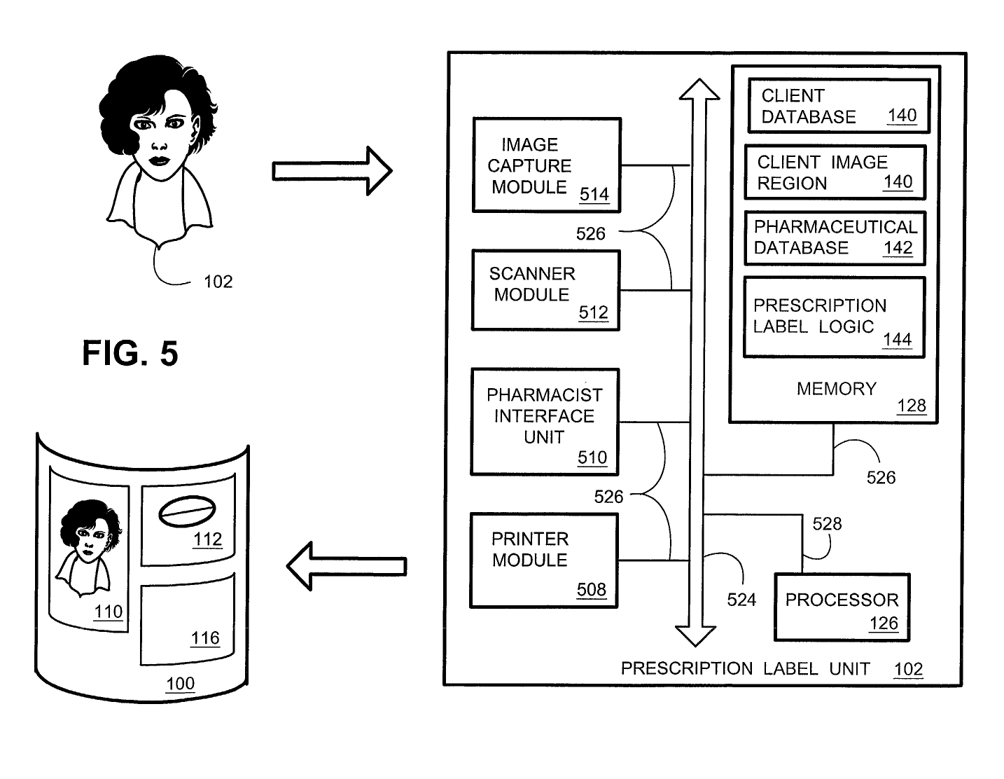

FIG. 5 is a block diagram illustrating an alternative embodiment of a prescription label unit 502 having at least a processor 504, a memory 506, a printer module 236, a pharmacist interface unit 510, a scanner module 512 and an image capture module 514. Memory 506 further includes a client image region 516 where at least one image of a client resides, a client data base 518 where information corresponding to the client resides, a pharmaceutical database 520 where information corresponding to prescription drugs reside, and prescription label logic 522. Memory 232 may also contain other data, logic and/or information used in the operation of prescription label unit 502, however such data, logic and/or information are described herein only to the extent necessary to describe the present invention.

For convenience, processor 504, memory 506, printer module 236, pharmacist interface unit 510, scanner module 512 and image capture module 514 are coupled to communication bus 524 via connections 526. Communication bus 524 is coupled to processor 504 via connection 528, thereby providing connectivity to the above-described components. In alternative embodiments of prescription label unit 502, the above-described components are connectivley coupled to processor 504 in a different manner than illustrated in FIG. 5. For example, one or more of the above-described components may be directly coupled to processor 504 or may be coupled to processor 504 via intermediary components (not shown).

Image capture module 514 is configured to capture an image of client 102. Components employed in image capture module 514 are similar to and operate similarly to the above-described digital camera 200 (FIGS. 2 and 3). When the pharmacist fills the prescription for client 102, a client image 110 is generated. Alternatively, client image 110 of client 102 may already reside in the client image region 516, and could be retrieved to generate client image 110.

Scanner module 514 is configured to scan a bar code on a bulk container of prescription drugs as described above. Components employed in scanner module 512 are similar to and operate similarly to the above-described scanner 210 (FIG. 2). When the pharmacist fills the prescription for client 102, the bulk container of prescription drugs is scanned to identify at least the prescription drugs that are used to fill the prescription.

Pharmacist interface unit 510 is a device configured to receive information from the pharmacist filling the prescription. In one embodiment, the pharmacist interface unit 510 is comprised of a plurality of input keys, much like keyboard 208 (FIG. 1). Other embodiments employ other suitable interfaces configured to receive information from the pharmacist.

Once a client 102 and the prescribed drug have been identified, prescription label logic 522, described in greater detail below, is executed such that prescription label 100 is prepared by retrieving an image of the client from the client database 250 or the image capture module 514, by retrieving an image of the prescribed drug from pharmaceutical database 252, and/or from selected information of interest. The above-described images and selected information is formatted by the prescription label logic 522 into a prescription label 100.

Once information corresponding to prescription label 100 is generated, prescription label 100 is printed by printer module 508. Printer module 508 is configured to appropriately format and print prescription label 100 on a suitable blank label (not shown), as described above. The pharmacist can verify the accuracy of prescription label 100 after printing, and if verified as accurate, affix prescription label to the drug container that will be dispensed to client 102.

The above-described prescription label unit 502 is recognized as a stand-alone, portable unit that can prepare a prescription label 100 in accordance with the present invention.

Alternative embodiments of a prescription label unit 502 may omit selected components. For example, scanner module 512 may be omitted. Accordingly, identification of the prescribed drug is based upon information provided by the pharmacist filling the prescription. Another embodiment omits pharmacist interface unit 510. For example, such an embodiment omitting pharmacist interface unit 510 could be configured to communicatively couple to a separate keyboard, or be configured to couple to an intermediary device, such as, but not limited to, a personal computer.

In another embodiment of prescription label unit 502, some of the above described components may by performed by single device. For example, image capture module 514 and scanner module 512 is implemented by a single device configured to capture images of client 102 and read bar codes on a bulk prescription container. Similarly, such a single device configured to capture images could also be configured to read and interpret textual information written by the pharmacist.

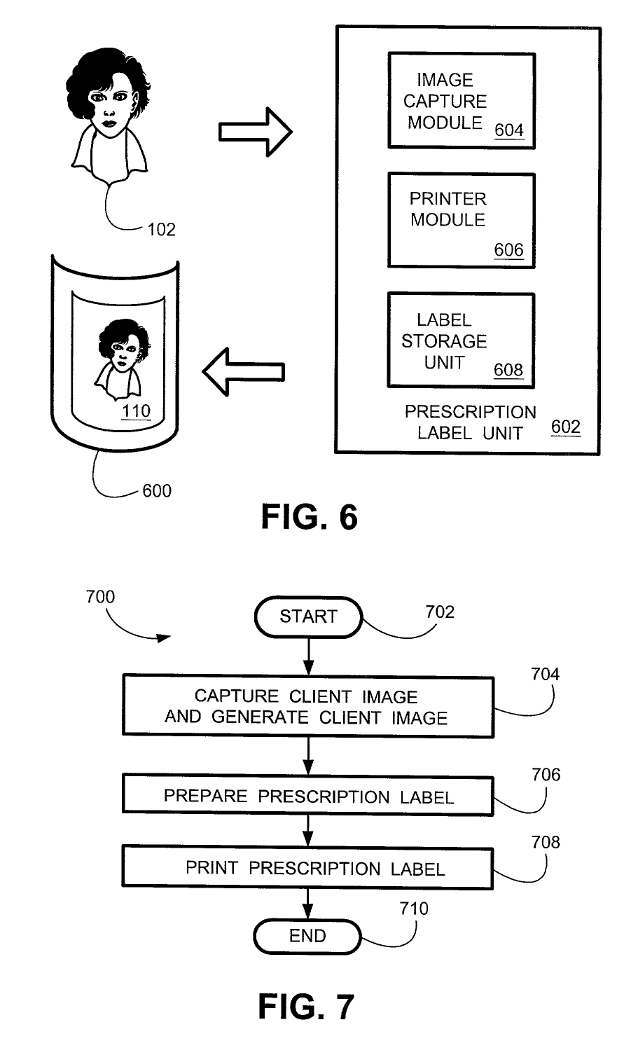

FIG. 6 is a block diagram illustrating an alternative embodiment of prescription label unit 602 having at least an image capture module 604, a printer module 606 and a label storage unit 608. Prescription label unit 602 may also contain other components, logic and/or information used in the operation of prescription label unit 602, however such components, logic and/or information are described herein only to the extent necessary to describe the present invention.

Image capture module 604 is configured to capture an image of client 102 and generate a client image 110. Components employed in image capture module 604 are similar to and operate similarly to the above-described digital camera 200 (FIGS. 2 and 3).

Once client image 110 is generated, client image 110 is printed by printer module 606. Printer module 606 is configured to appropriately format and print the prescription label 600 on a suitable blank label (not shown) residing in the label storage unit 608. The prescription label 600 having only the client image 110 may be made from any of the above-described embodiments of prescription label 100. Accordingly, this embodiment of the present invention is configured to provide an image of client 102 that is affixed to a prescription container that already has other information on a second label.

FIG. 7 is a flowchart 700 of a process describing one embodiment of the present invention. Flowchart 700 shows the architecture, functionality, and operation of one implementation of a system for preparing prescription labels 600 in accordance with the present invention. In this regard, each block represents a module, segment, or portion of code, which comprises one or more executable instructions for implementing the specified logical function(s). It should also be noted that in some alternative implementations, the functions noted in the blocks may occur out of the order noted in FIG. 7. For example, two blocks shown in succession in FIG. 7 may in fact be executed substantially concurrently or the blocks may sometimes be executed in the reverse order, depending upon the functionality involved, as will be further clarified hereinbelow.

The process of preparing a prescription label 600 using an embodiment of prescription label unit 602 starts at block 702. At block 704, an image of the client 102 is captured and client image 110 is generated. At block 706 a prescription label 600 is prepared. At block 708 prescription label 600 is printed. The process ends at block 710.

The above-described embodiments of prescription label 100 comprised a client image, an image of the prescribed drug and prescription information. An alternative embodiment prepares a prescription label comprising a client image and prescription information. Another alternative embodiment prepares a prescription label comprising other information of interest, such as, but not limited to, information identifying the pharmacy, information identifying the pharmacist filling the prescription, date that the prescription was filed, the prescribing doctor, emergency contact information, medical and/or legal warnings, or the like.

It should be emphasized that the above-described embodiments of the present invention, particularly, any “preferred” embodiments, are merely examples of implementations, merely set forth for a clear understanding of the principles of the invention. Many variations and modifications may be made to the above-described embodiment(s) of the invention without departing substantially from the spirit and principles of the invention. All such modifications and variations are intended to be included herein within the scope of this disclosure and the present invention and protected by the following claims.

Therefore, having thus described the invention, at least the following is claimed:

1. A prescription label, comprising:
an image of a client who is intended to consume a prescribed drug; and
a prescription information region identifying at least the prescribed drug.

2. The label of claim 1, further comprising the image of the prescribed drug.

3. The label of claim 1, further comprising the image of a container wherein the prescribed drug resides.

4. The label of claim 1, further comprising a comment section, the comment section corresponding to selected information retrieved from a pharmaceutical database having information corresponding to the prescribed drug.

5. The label of claim 1, further comprising a comment section, the comment section corresponding to selected information retrieved from a client database having information corresponding to the client.

6. The label of claim 1, further comprising a comment section, the comment section corresponding to information received from an interface device, the information corresponding to selected information generated by a pharmacist.

7. A system for creating prescription labels, comprising:
a processor configured to receive an image of a client and configured to generate a prescription label, the prescription label corresponding to a prescription drug prescribed to the client; and
a printer interface configured to communicate the prescription label having at least the image of the client.

8. The system of claim 7, further comprising a memory for storing at least a pharmaceutical database, the pharmaceutical database having at least information corresponding to the prescription drug such that when the processor prepares the prescription label, selected information corresponding to the prescribed drug is included on the prescription label.

9. The system of claim 7, further comprising a scanner configured to scan a bar code residing on a prescription drug bulk container such that the prescribed drug is identified.

10. The system of claim 7, further comprising an input device configured to receive information from a pharmacist such that the prescribed drug is identified.

11. The system of claim 7, further comprising a printer configured to print the prescription label, the prescription label configured to be affixed to a prescription drug container.

12. The system of claim 7, further comprising a display configured to display the prescription label so that information associated with the prescription label can be verified by a pharmacist filling a prescription for the prescribed drug.

13. The system of claim 7, further comprising an image capture device configured to capture at least the image of the client such that the image of the client is communicated to the processor.

14. The system of claim 7, further comprising a memory for storing at least the image of the client such that the image of the client is communicated to the processor.

15. A method for preparing prescription labels, the method comprising the steps of:
capturing of an image who is intended to consume a prescribed drug; and
generating a prescription label having at least the image of the client.

16. The method of claim 15, further comprising the step of printing the prescription label having at least the image of the client.

17. The method of claim 15, further comprising the steps of:
identifying the prescribed drug;
retrieving selected information from a pharmaceutical database, the selected information corresponding to the prescribed drug; and
generating the prescription label having the selected information corresponding to the prescribed drug.

18. The method of claim 17, further comprising the steps of:
retrieving an image of the prescribed drug from the pharmaceutical database; and
generating the prescription label having the image of the prescribed drug.

19. The method of claim 17, further comprising the steps of:
receiving information identifying the prescribed drug; and
generating the prescription label identifying the prescribed drug.

20. The method of claim 17, further comprising the step of receiving information from a pharmacist identifying the prescribed drug.

21. The method of claim 17, further comprising the step of receiving information corresponding to a scanned bar code residing on a bulk container having the prescribed drug, such that the prescribed drug is identified.

22. The method of claim 15, further comprising the steps of:
capturing an image of the prescribed drug; and
generating the prescription label having the image of the prescribed drug.

23. The method of claim 15, further comprising the steps of:
identifying the client;
retrieving selected information from a client database, the selected information corresponding to the client; and
generating the prescription label having the selected information corresponding to the client.

24. A method for identifying prescription drug containers, the method comprising the step of affixing a prescription label to the prescription drug container, the prescription label having at least a captured image of a client who is intended to consume a prescribed drug.

25. The method of claim 24, wherein the prescription label further includes an image of the prescribed drug.

26. A computer readable medium having a program for preparing prescription labels, the program comprising logic configured to perform the steps of:
receiving a captured image of a client who is intended to consume a prescribed drug;
generating a prescription label having at least the captured image of the client.

27. The computer readable medium of claim 26, further comprising logic configured to perform the steps of:
receiving information identifying the prescribed drug;
retrieving selected information from a pharmaceutical database, the selected information corresponding to the prescribed drug and having at least an image of the prescribed drug; and
generating the prescription label having information identifying the prescribed drug and having an image of the prescribed drug.

28. The computer readable medium of claim 26, further comprising logic configured to perform the steps of:
receiving information from a scanned bar code residing on a bulk container having the prescribed drug such that the prescribed drug is identified; and
retrieving selected information from a pharmaceutical database, the selected information corresponding to the prescribed drug; and
generating the prescription label having the selected information corresponding to the prescribed drug.

29. The computer readable medium of claim 26, further comprising the steps of:
receiving information identifying the client;
retrieving selected information from a client database, the selected information corresponding to the client; and
generating the prescription label having the selected information corresponding to the client.
